(19) United States
(12) Patent Application Publication
(10) Pub. No.: US 2025/0305582 A1
(43) Pub. Date: Oct. 2, 2025

(54) OIL RING AND METHOD FOR MANUFACTURING OIL RING

(71) Applicant: NIPPON PISTON RING CO., LTD., Saitama City, Saitama (JP)

(72) Inventors: Michihiro ITO, Saitama City, Saitama (JP); Hajime ANDO, Saitama City, Saitama (JP); Shinya KANAZAWA, Saitama City, Saitama (JP); Makoto KAJIWARA, Saitama City, Saitama (JP); Yoshihiro ITO, Saitama City, Saitama (JP)

(21) Appl. No.: 18/866,174

(22) PCT Filed: Aug. 2, 2023
(86) PCT No.: PCT/JP2023/028323

§ 371 Date: Nov. 15, 2024

(30) Foreign Application Priority Data
Aug. 31, 2022 (JP) 2022-138584

(51) Int. Cl. F16J 9/06

(52) U.S. Cl. CPC F16J 9/06

(57) ABSTRACT

An oil ring is a multi-piece-type oil ring provided on a piston of an internal combustion engine including a ring body having a rail, and an expander. In the oil ring, the rail of the ring body is provided with a film formed by physical vapor deposition. An outer peripheral face of the rail formed by the film includes: an actual land face formed to have a strip shape extending in a circumferential direction and abutting against and sliding on an inner wall face of a cylinder of the internal combustion engine; and an inclined face continuing from an edge of the actual land face in an axial direction to an outside and having a larger distance from the inner wall face on a further outside in the axial direction. The inclined face includes a face obtained by polishing or grinding a surface of the film along the circumferential direction.

### CROSS REFERENCE TO RELATED APPLICATIONS

This application is a 371 U.S. National Phase of International Application No. PCT/JP2023/028323, filed on Aug. 2, 2023, which claims priority to Japanese Patent Application No. 2022-138584, filed Aug. 31, 2022. The entire disclosures of the above applications are incorporated herein by reference.

### BACKGROUND

### Technical Field

The present invention relates to an oil ring in an internal combustion engine including a cylinder and a piston, a method for manufacturing the same, and the like.

### Related Art

An effective way to reduce fuel consumption of an engine is reduction of friction between a piston ring and a cylinder liner. In recent years, an oil ring that serves as a kind of piston ring has been subjected to a nitriding treatment, a coating with chromium nitride by using a PVD treatment, this chromium nitride serving as a material having a low friction coefficient, a DLC coating, or the like to reduce friction.

Also, the outer peripheral face of the oil ring is formed to have a step land (stepped) shape to reduce the actual land width between the cylinder liner and the sliding face serving as the tip end of the outer peripheral face, thereby acquiring a sufficient contact face pressure even with a small tensile force. In this case, since the face pressure of the sliding face is large, the nitriding treatment alone cannot ensure sufficient abrasion resistance, and a PVD treatment or the like that can achieve a high hardness film is employed in some cases (refer to Japanese Patent No. 5871277).

Although the following is an unpublicized problem at the time of filing the present application, it has been clear that there is room for further improvement when forming a high hardness film by means of a physical vapor deposition treatment on the sliding face of an oil ring to bring about a friction reduction effect. In view of such circumstances, an object of the present invention is to provide an oil ring whose sliding resistance is further reduced and that can achieve improvement in fuel consumption.

### SUMMARY

The present invention that achieves the above-mentioned object provides an oil ring that is a multi-piece-type oil ring provided on a piston of an internal combustion engine including a ring body having a rail, and an expander applying a tensile force to the ring body. In the oil ring, the rail of the ring body is provided with a film formed by means of a physical vapor deposition treatment, an outer peripheral face of the rail formed by the film includes: an actual land face that is formed to have a strip shape that extends in a circumferential direction and that abuts against and slides on an inner wall face of a cylinder of the internal combustion engine; and an inclined face that continues from an edge of the actual land face in an axial direction to an outside in the axial direction and has a larger distance from the inner wall face on a further outside in the axial direction, and the inclined face includes a face obtained by polishing or grinding a surface of the film along the circumferential direction.

As for the oil ring described above, the actual land face may be constituted by a face obtained by polishing or grinding a surface of the film along the axial direction.

As for the oil ring described above, in a case where a position in which an inclination angle of the inclined face with reference to the axial direction is 7° is defined as an assessment position, a reduced peak height Rpk obtained by measuring the assessment position along the circumferential direction may be 0.15 μm or less.

As for the oil ring described above, in a case where a position in which an inclination angle of the inclined face with reference to the axial direction is 7° is defined as an assessment position, a material ratio Rmr, in a case of generating a 0.3 μm height decrease with a 0.5% position as a starting point, obtained by measuring the assessment position along the circumferential direction may be 35% or more.

As for the oil ring described above, the inclined face may include a hairline that extends in the circumferential direction and that is formed by the polishing or the grinding.

As for the oil ring described above, the actual land face may include a hairline that extends in the axial direction and that is formed by polishing or grinding.

As for the oil ring described above, the film may be a chromium nitride-based alloy film or a hard carbon film.

The present invention, which achieves the above-mentioned object, provides a method for manufacturing an oil ring that is a multi-piece-type oil ring provided on a piston of an internal combustion engine including a ring body having a rail, and an expander applying a tensile force to the ring body. The method for manufacturing an oil ring includes the steps of: forming a film on the rail of the ring body by means of a physical vapor deposition treatment; forming a peripheral-direction abrasion face on a surface of the film by polishing or grinding an outer peripheral face of the rail formed by the film along a circumferential direction; and forming, on a surface of the film, an actual land face that abuts against and slides on an inner wall face of a cylinder of the internal combustion engine by polishing or grinding a part of the peripheral-direction abrasion face along an axial direction. In the method for manufacturing an oil ring, by leaving the peripheral-direction abrasion face in a portion from an edge of the actual land face in the axial direction to an outside in the axial direction, the peripheral-direction abrasion face is allowed to serve as an inclined face which has a larger distance from the inner wall face on a further outside in the axial direction.

### Advantageous Effects of Invention

The present invention can achieve an excellent effect of further reducing sliding resistance of an oil ring and improving fuel consumption thereof.

### BRIEF DESCRIPTION OF THE DRAWINGS

FIG. 1(A) is a side view illustrating a piston and a piston ring to which an oil ring according to an embodiment of the present invention is applied, FIG. 1(B) is a partially enlarged cross-sectional view illustrating the piston and the piston ring, FIG. 1(C) is a partially enlarged cross-sectional view of a top ring, and FIG. 1(D) is a partially enlarged cross-sectional view of a second ring.

FIG. 2 is a cross-sectional view of the two-piece-type oil ring according to the present embodiment.

FIG. 3 is an axial-direction cross-sectional view illustrating an enlarged view of a portion around an outer peripheral face of the oil ring.

FIG. 4(A) is an axial-direction cross-sectional view illustrating an enlarged view of a portion around the outer peripheral face of the oil ring after a physical vapor deposition treatment in a process of manufacturing the oil ring, FIG. 4(B) is a partial cross-sectional view illustrating a state of the oil ring which is subjected to buffing, and FIG. 4(C) is a perspective view illustrating an enlarged view of a portion around the outer peripheral face of the oil ring after the buffing.

FIG. 5(A) is a partial cross-sectional view illustrating a state of the oil ring which is subjected to lapping, and FIG. 5(B) is a perspective view illustrating an enlarged view of a portion around the outer peripheral face of the oil ring after the lapping.

FIG. 6(A) is a cross-sectional view of a three-piece-type oil ring, which is a modification example of the oil ring according to the present embodiment, and FIG. 6(B) is an axial-direction cross-sectional view illustrating an enlarged view of a portion around an outer peripheral face of the oil ring.

FIG. 7(A) is a Stribeck curve graph regarding sliding of a common internal combustion engine, and FIG. 7(B) is an FMEP curve graph regarding the same.

FIG. 8 is a cross-sectional view along an axial direction of a cylinder liner of an internal combustion engine to which the oil ring is applied.

FIGS. 9(A) and 9(B) are developed views each illustrating a state in which an inner peripheral wall of the cylinder liner is developed in a circumferential direction.

FIG. 10 is a cross-sectional view of the inner peripheral wall of the cylinder liner in a direction perpendicular to the axis.

FIGS. 11(A) to 11(C) are graphs illustrating actual measurement results of surface texture parameters, in the circumferential direction, of the oil rings in first and second examples.

FIGS. 12(A) and 12(B) are graphs illustrating actual measurement results of surface texture parameters, in the circumferential direction, of the oil rings in the first and second examples.

FIGS. 13(A) to 13(C) are graphs illustrating actual measurement results of surface texture parameters, in the circumferential direction, of the oil rings in the first and second examples.

FIGS. 14(A) to 14(D) are image capturing views illustrating results of three-dimensional image capturing of surface texture, in the circumferential direction, of the oil ring in the first example.

FIGS. 15(A) to 15(D) are image capturing views illustrating results of three-dimensional image capturing of surface texture, in the circumferential direction, of the oil ring in the second example.

FIGS. 16(A) to 16(D) are image capturing views illustrating results of three-dimensional image capturing of surface texture, in the circumferential direction, of an oil ring in a comparative example.

FIG. 17 is an FMEP curve graph of an internal combustion engine measured with use of the oil rings in the example and the comparative example.

### DETAILED DESCRIPTION

Hereinbelow, an oil ring and a method for manufacturing the same according to an embodiment of the present invention will be described with reference to the accompanying drawings.

First, a sliding structure of an internal combustion engine including an oil ring according to the present embodiment will be described.

### <Structures of Piston and Piston Ring>

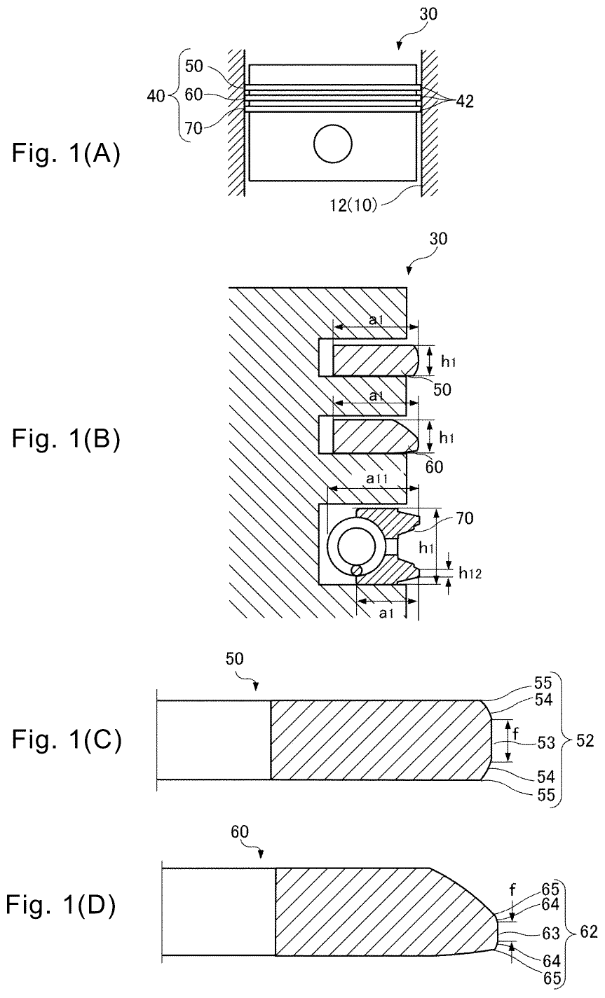

FIGS. 1(A) and 1(B) illustrate, as a part of a gasoline engine, a piston 30 and piston rings 40 (a top ring 50, a second ring 60, and an oil ring 70) provided on ring grooves of the piston 30. The piston rings 40 reciprocate in the cylinder axial direction in a state where outer peripheral faces 42 thereof are opposed to an inner wall face 12 of a cylinder liner 10. The top ring 50 fills a gap between the piston 30 and the cylinder liner 10 to avoid a gas leakage phenomenon (blow-by) in which compressed gas leaks from a combustion chamber to a crank case side. The second ring 60 plays a role of filling a gap between the piston 30 and the cylinder liner 10 in a similar manner to the top ring 50 and also a role of scraping an excess engine oil attached to the inner wall face 12 of the cylinder liner 10. In some cases, the top ring 50 and the second ring 60 are referred to as compression rings.

The oil ring 70 scrapes an excess engine oil attached to the inner wall face 12 of the cylinder liner 10 and forms an appropriate oil film to prevent the piston 30 from scuffing.

### <Shape of Top Ring>

As illustrated in an enlarged view of FIG. 1(C), the top ring 50 is a single annular member, and the cross-section of an outer peripheral face 52 thereof has a so-called weak-barrel shape, which is a slightly protruded shape protruded toward the outside in the radial direction. Note that, in FIG. 1(C), for convenience of description, the dimension in the radial direction with respect to the dimension in the axial direction is significantly exaggerated to emphasize the protruded shape of the outer peripheral face.

The thickness (radial-direction thickness) a₁ of the top ring 50 is set to, for example, 6.0 mm or less, and preferably 4.5 mm or less. The width (axial-direction width) h₁ is set to, for example, 3.5 mm or less, and preferably 3.0 mm or less.

A part of the outer peripheral face 52 in the axial direction is provided with an actual land face 53. The actual land face 53 is a strip-like region that extends in the circumferential direction of the outer peripheral face 52. The actual land face 53 means a sliding region (sliding face) that comes in contact with and slides on the inner wall face 12 of the cylinder liner 10. The outer peripheral face 52 is further provided with inclined faces 54 and corners 55, which extend from each of edges of the actual land face 53 in the axial direction (strip width direction) toward the outside. The inclined faces 54 and the corners 55 are regions separated from the inner wall face 12 of the cylinder liner 10.

The dimension of an actual land width f of the actual land face 53 before a running-in operation is preferably set to 0.15 mm or more. The dimension is more preferably set to 0.3 mm or more, still more preferably set to more than 0.3 mm, and especially preferably set to 0.4 mm or more.

To positively form a shear droop shape by the running-in operation, the surface hardness of the outer peripheral face 52 is preferably 2,000 Hv or less, and is set to 1,800 Hv herein.

### <Shape of Second Ring>

As illustrated in the enlarged view of FIG. 1(D), the second ring 60 is a single annular member, and the cross-section of an outer peripheral face 62 thereof has a taper shape. The flat face on the tip end side of the taper shape has a so-called weak-barrel shape, which is a slightly protruded shape protruding toward the outside in the radial direction. Note that, in FIG. 1(D), for convenience of description, the dimension in the radial direction with respect to the dimension in the axial direction is significantly exaggerated to emphasize the protruded shape of the outer peripheral face.

The thickness (radial-direction thickness) a₁ of the second ring 60 is set to, for example, 6.0 mm or less, and preferably 4.5 mm or less. The width (axial-direction width) h₁ is set to, for example, 3.0 mm or less, and preferably 2.5 mm or less.

In a similar manner to the top ring 50, a part of the outer peripheral face 62 in the axial direction is provided with an actual land face 63. The actual land face 63 is a strip-like region that extends in the circumferential direction of the outer peripheral face 62. The actual land face 63 means a sliding region (sliding face) that comes in contact with and slides on the inner wall face 12 of the cylinder liner 10. The outer peripheral face 62 is further provided with inclined faces 64 and corners 65 from each of edges of the actual land face 63 in the axial direction (strip width direction) toward the outside. The inclined faces 64 and the corners 65 are regions separated from the inner wall face 12 of the cylinder liner 10.

The dimension of an actual land width f of the actual land face 63 before a running-in operation is preferably set to 0.15 mm or more. The dimension is more preferably 0.3 mm or more, still more preferably more than 0.3 mm, and especially preferably 0.4 mm or more.

To positively form a shear droop shape by the running-in operation, the surface hardness of the outer peripheral face 62 is preferably 1,600 Hv or less, and is set to 1,400 Hv herein.

### <Shape of Oil Ring>

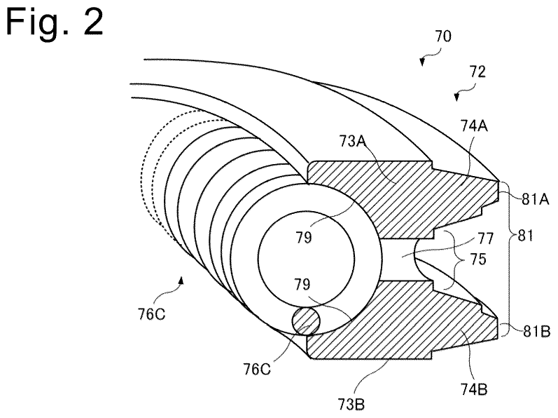

FIG. 2 is an enlarged view of the two-piece-type oil ring 70 according to the present embodiment. The oil ring 70 includes a ring body 72 and a coil expander 76C having a coil spring shape.

The ring body 72 integrally includes an upper side rail 73A and a lower side rail 73B, which are arranged at both the ends in the axial direction and have annular shapes, and an annular column 75, which is arranged between the upper side rail 73A and the lower side rail 73B and that connects the rails. The cross-sectional shape of a combination of the upper side rail 73A and the lower side rail 73B as a pair and the column 75 is substantially an I shape or H shape. With use of this shape, the ring body 72 is provided on the inner peripheral face side thereof with an inner peripheral groove 79 having a semi-arc-shaped cross-section for housing the coil expander 76C.

The respective outer peripheries of the upper side rail 73A and the lower side rail 73B are correspondingly provided with an upper side annular projection 74A and a lower side annular projection 74B projecting outward in the radial direction with reference to the column 75. Around the tip ends of the upper side annular projection 74A and the lower side annular projection 74B, an upper side outer peripheral face 81A and a lower side outer peripheral face 81B are provided.

The coil expander 76C is housed in the inner peripheral groove 79 to press and bias the ring body 72 to the outside in the radial direction. The column 75 of the ring body 72 is provided with a plurality of oil return slots 77 in the circumferential direction.

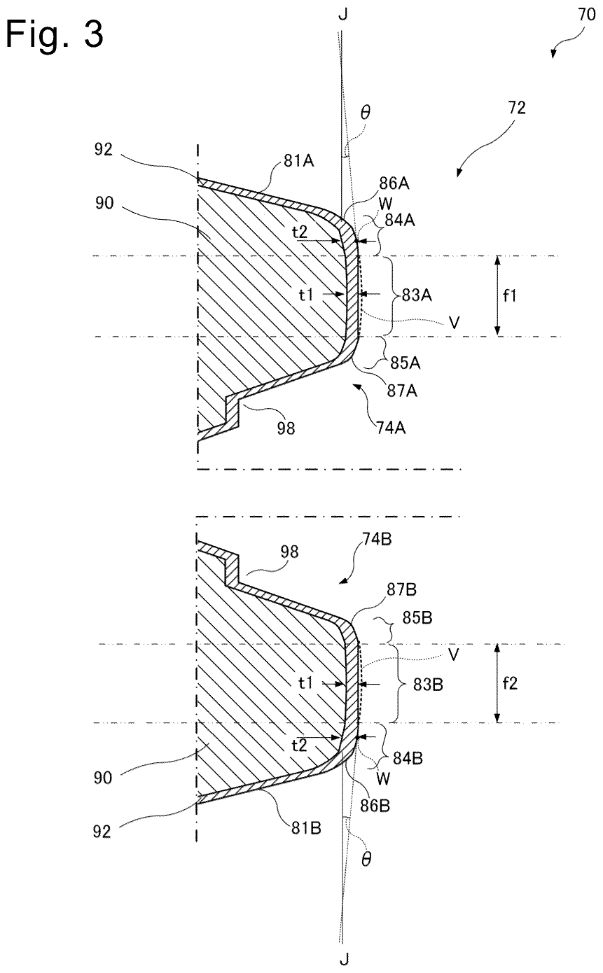

As illustrated in the enlarged view of FIG. 3, each of the upper side outer peripheral face 81A and the lower side outer peripheral face 81B is a surface of a hard film (hereinbelow, a PVD film) 92 formed on the surface of a base material 90 by means of a physical vapor deposition treatment. The material for the base material 90 is, for example, 8Cr steel, 10Cr steel, or 13Cr SUS. Also, as the PVD film 92, for example, a chromium nitride-based alloy film such as Cr—N-based, Cr—B—N-based, Cr—B—V—N-based, and Cr—B—Ti—V—(Mn, Mo)—N-based alloy films and a hard carbon film (also referred to as a diamond-like carbon film or a DLC film) can be employed. The hydrogen content in the hard carbon film is preferably 10 atom % or less. The surface hardness of the PVD film 92 is preferably 2,000 Hv or less, and is set to 1,800 Hv herein.

### (Description of Actual Land Face)

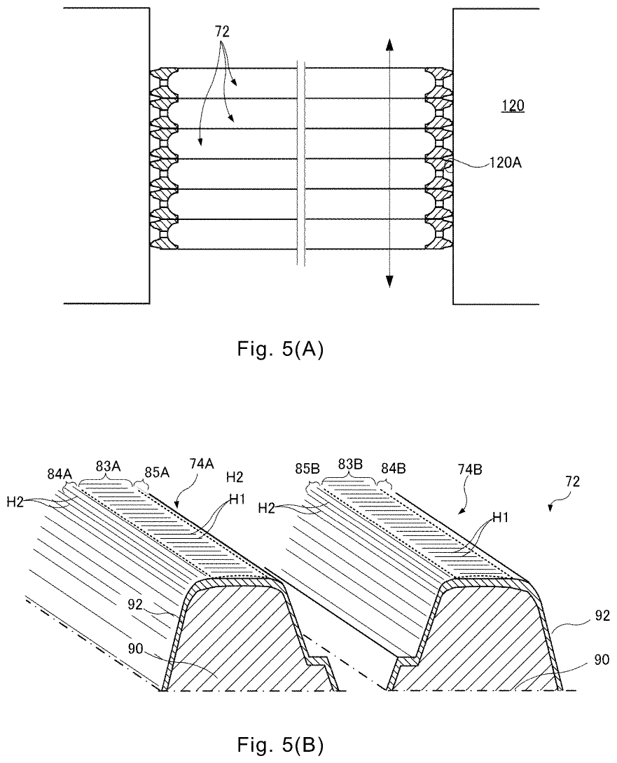

A part of the upper side outer peripheral face 81A and a part of the lower side outer peripheral face 81B are provided with an upper side actual land face 83A and a lower side actual land face 83B that actually abut against the inner wall face 12 of the cylinder liner 10, respectively. Each of the upper side actual land face 83A and the lower side actual land face 83B is a strip-like region that extends in the circumferential direction. Each of the upper side actual land face 83A and the lower side actual land face 83B is a flat face (refer to dotted line V) created by abrasion of a part of the surface side of the PVD film 92, wherein the abrasion is achieved by lapping in which polishing or grinding is performed in the axial direction (strip width direction). As illustrated in FIG. 5(B), fine axial-direction hairlines H1 that extend in the axial direction (strip width direction) and that serve as polishing marks are formed on the surfaces of the upper side actual land face 83A and the lower side actual land face 83B.

The thickness t1 of the PVD film 92 in the radial direction at the center part, in the axial direction, of each of the upper side actual land face 83A and the lower side actual land face 83B is preferably 5 μm or more, and more preferably 10 μm or more. The thickness t1 of the PVD film 92 is preferably 50 μm or less, and more preferably 40 μm or less. The thickness t1 is set to 20 μm herein.

The upper side outer peripheral face 81A and the lower side outer peripheral face 81B are formed integrally with the ring body 72. Therefore, the upper side outer peripheral face 81A and the lower side outer peripheral face 81B can be combined and defined as a single outer peripheral face 81 (refer to FIG. 2). A gap is formed at the center of the single outer peripheral face 81.

Returning to FIG. 3, on the side (lower side), closer to the column 75 in the axial direction, of the upper side actual land face 83A, a recessed step 98 recessed so that a part of the upper side outer peripheral face 81A is decreased in diameter is provided. Similarly, on the side (upper side), closer to the column 75 in the axial direction, of the lower side actual land face 83B, a recessed step 98 recessed so that a part of the lower side outer peripheral face 81B is decreased in diameter is provided. Due to these recessed steps 98, the upper side outer peripheral face 81A and the lower side outer peripheral face 81B are stepped. As a result, actual land widths (strip widths) f1 and f2 of the upper side actual land face 83A and the lower side actual land face 83B can be set to be small. In other words, each of the upper side annular projection 74A and the lower side annular projection 74B has a two-step projecting shape, and this shape is referred to as a step land shape. The recessed step 98 can be formed, for example, by grinding the base material 90, or can alternatively be formed in advance at the time of drawing process of a wire rod.

### (Description of Inclined Face)

In the upper side outer peripheral face 81A, the edges of the upper side actual land face 83A in the axial direction (strip width direction) are provided with an upper side first inclined face 84A and an upper side second inclined face 85A, respectively. The upper side first inclined face 84A is on the side far from the spacer expander 76C while the upper side second inclined face 85A is on the side near the spacer expander 76C. The upper side first inclined face 84A is an inclined region in which the distance from the inner wall face 12 of the cylinder liner 10 becomes larger at a farther position from the upper side actual land face 83A to the upper side. The upper side second inclined face 85A is an inclined region in which the distance from the inner wall face 12 of the cylinder liner 10 becomes larger at a farther position from the upper side actual land face 83A to the lower side. Each of the upper side first inclined face 84A and the upper side second inclined face 85A is a strip-like region that extends in the circumferential direction.

In addition, on the outside (upper side) of the upper side first inclined face 84A in the axial direction, an upper side first corner 86A is formed. In the cross-sectional view in the axial direction, the upper side first corner 86A is a region in which the gradient of the inclination changes rapidly from the upper side first inclined face 84A toward the upper side lateral face of the upper side annular projection 74A.

On the outside (lower side) of the upper side second inclined face 85A in the axial direction, an upper side second corner 87A is formed. In the cross-sectional view in the axial direction, the upper side second corner 87A is a region in which the gradient of the inclination changes rapidly from the upper side second inclined face 85A toward the lower side lateral face of the upper side annular projection 74A.

In the lower side outer peripheral face 81B, the edges of the lower side actual land face 83B in the axial direction (strip width direction) are provided with a lower side first inclined face 84B and a lower side second inclined face 85B, respectively. The lower side first inclined face 84B is on the side far from the spacer expander 76C while the lower side second inclined face 85B is on the side near the spacer expander 76C. The lower side first inclined face 84B is an inclined region in which the distance from the inner wall face 12 of the cylinder liner 10 becomes larger at a farther position from the lower side actual land face 83B to the lower side. The lower side second inclined face 85B is an inclined region in which the distance from the inner wall face 12 of the cylinder liner 10 becomes larger at a farther position from the lower side actual land face 83B to the upper side. Each of the lower side first inclined face 84B and the lower side second inclined face 85B is a strip-like region that extends in the circumferential direction.

In addition, on the outside (lower side) of the lower side first inclined face 84B in the axial direction, a lower side first corner 86B is formed. In the cross-sectional view in the axial direction, the lower side first corner 86B is a region in which the gradient of the inclination changes rapidly from the lower side first inclined face 84B toward the lower side lateral face of the lower side annular projection 74B.

On the outside (upper side) of the lower side second inclined face 85B in the axial direction, a lower side second corner 87B is formed. In the cross-sectional view in the axial direction, the lower side second corner 87B is a region in which the gradient of the inclination changes rapidly from the lower side second inclined face 85B toward the upper side lateral face of the lower side annular projection 74B.

As illustrated in FIG. 5(B), at least the upper side first inclined face 84A and the lower side first inclined face 84B are surfaces obtained by polishing or grinding a part of the PVD film 92 on the surface side along the circumferential direction by means of buffing to be described below. As a result, the upper side first inclined face 84A and the lower side first inclined face 84B are smoothed along the circumferential direction. Fine peripheral-direction hairlines H2 that extend in the circumferential direction (strip length direction) and that serve as polishing marks are formed on the surfaces of the upper side first inclined face 84A and the lower side first inclined face 84B.

In the present embodiment, the upper side first inclined face 84A and the lower side first inclined face 84B, and the upper side second inclined face 85A and the lower side second inclined face 85B are all smoothed by polishing or grinding by means of buffing, and the fine peripheral-direction hairlines H2 are formed on the surfaces thereof.

Returning to FIG. 1, a combined radial-direction thickness a₁₁ (refer to FIG. 1(B)) of the oil ring 70 is set to, for example, 5.0 mm or less, and preferably 4.5 mm or less. A combined axial-direction width (nominal width) h₁ (refer to FIG. 1(B)) is set to, for example, 4.0 mm or less, and preferably 3.0 mm or less. The thickness (radial-direction width) a₁ (refer to FIG. 1(B)) of the upper side rail 73A or the lower side rail 73B as a single unit is set to, for example, 4.0 mm or less, and preferably 3.0 mm or less. The width (axial-direction width) h₁₂ (refer to FIG. 1(B)) of the single unit is set to, for example, 0.40 mm or less, preferably 0.30 mm or less, and more preferably 0.20 mm or less.

The dimensions of the upper side actual land width f1 of the upper side actual land face 83A and the lower side actual land width f2 of the lower side actual land face 83B before a running-in operation are each preferably set to 0.05 mm or more. The dimension is more preferably set to 0.10 mm or more, and still more preferably set to more than 0.13 mm. Also, the dimensions of the upper side actual land width f1 and the lower side actual land width f2 are each preferably set to 0.40 mm or less. The dimension is more preferably set to 0.35 mm or less, and still more preferably set to less than 0.30 mm.

In addition, a total actual land width F obtained by summing up the upper side actual land width f1 and the lower side actual land width f2 is preferably set to 0.10 mm or more. The width is more preferably set to 0.20 mm or more, and still more preferably set to more than 0.26 mm. The total actual land width F is preferably set to 0.80 mm or less. The width is more preferably set to 0.70 mm or less, and still more preferably set to less than 0.60 mm. Furthermore, a face pressure acting on the upper side actual land face 83A and the lower side actual land face 83B is preferably set to 0.8 MPa or more, and more preferably set to 1.0 MPa or more. The face pressure is preferably set to 2.5 MPa or less, and more preferably set to 2.2 MPa or less.

### (Assessment of Surface Roughness of Inclined Face in Circumferential Direction)

In the present embodiment, an assessment position W is defined in order to assess the surface roughness of the upper side first inclined face 84A and the lower side first inclined face 84B in the circumferential direction. As illustrated in FIG. 3, in the cross-sectional view in the axial direction, a point in which an inclination angle θ of the upper side first inclined face 84A and the lower side first inclined face 84B with reference to an axial direction J of the oil ring 70 is 7° is defined as the assessment position W. A surface texture value obtained by measuring the assessment position W along the circumferential direction using a stylus surface roughness measuring instrument (JIS B 0651: 2001) is defined as “a peripheral-direction surface texture parameter of the inclined face”. Measurement is performed using a measurement stylus in which the tip end radius is a standard value of 2 μm, the tip end shape is a 60⁰ knife edge shape, and the cutoff wavelength λc for profile curve is 0.8 mm.

In the present embodiment, in the upper side first inclined face 84A and the lower side first inclined face 84B, an arithmetic mean roughness Ra (JIS B 0601: 2013) serving as the peripheral-direction surface texture parameter is preferably set to less than 0.18 μm, and more preferably set to 0.10 μm or less.

In the present embodiment, in the upper side first inclined face 84A and the lower side first inclined face 84B, a maximum height Rz (JIS B 0601: 2013) serving as the peripheral-direction surface texture parameter is preferably set to less than 1.40 μm, and more preferably set to 1.00 μm or less.

In the present embodiment, in the upper side first inclined face 84A and the lower side first inclined face 84B, a ten point height of roughness profile RzJIS (JIS B 0601: 2013) serving as the peripheral-direction surface texture parameter is preferably set to 1.10 μm or less, and more preferably se to 0.80 μm or less.

In the present embodiment, in the upper side first inclined face 84A and the lower side first inclined face 84B, a reduced peak height Rpk (JIS B 0671-2: 2002) serving as the peripheral-direction surface texture parameter is preferably set to 0.15 μm or less, and more preferably set to 0.10 μm or less.

In the present embodiment, in the upper side first inclined face 84A and the lower side first inclined face 84B, a core roughness depth Rk (JIS B 0671-2: 2002) serving as the peripheral-direction surface texture parameter is preferably set to 0.50 μm or less, and more preferably set to 0.30 μm or less.

In the present embodiment, in the upper side first inclined face 84A and the lower side first inclined face 84B, a material ratio Rmr (JIS B 0601: 2013), serving as the peripheral-direction surface texture parameter, in a case of generating a 0.3 μm height decrease with a 0.5% position as a starting point is preferably set to 35% or more, and more preferably set to 75% or more.

In the present embodiment, in the upper side first inclined face 84A and the lower side first inclined face 84B, a material ratio Rmr (JIS B 0601: 2013), serving as the peripheral-direction surface texture parameter, in a case of generating a 0.4 μm height decrease with a 0.5% position as a starting point is preferably set to 55% or more, and more preferably set to 80% or more.

In the present embodiment, in the upper side first inclined face 84A and the lower side first inclined face 84B, a material ratio Rmr (JIS B 0601: 2013), serving as the peripheral-direction surface texture parameter, in a case of generating a 0.5 μm height decrease with a 0.5% position as a starting point is preferably set to 70% or more, and more preferably set to 85% or more.

The thickness t2 of the PVD film 92 in the radial direction at the assessment position W of each of the upper side first inclined face 84A and the lower side first inclined face 84B is preferably 5 μm or more, and more preferably 10 μm or more. The thickness t2 of the PVD film 92 is preferably 50 μm or less, and more preferably 40 μm or less. The thickness t2 is set to 20 μm herein.

### (Slight Modification of Actual Land Face Due to Running-in Operation)

Meanwhile, herein the states of the upper side actual land face 83A and the lower side actual land face 83B are the states at the time of completion of manufacturing. When the oil ring 70 is attached to the piston 30 and is subjected to an actual running-in operation with the cylinder liner 10, the shapes of the upper side actual land face 83A and the lower side actual land face 83B are slightly modified due to the contact abrasion thereof. Specifically, due to the abrasion as a result of the running-in operation, each of the upper side actual land face 83A and the lower side actual land face 83B is in a barrel shape where the faces slightly incline from the center to the two outsides in the cylinder axial direction. The inclination formed in each of the upper side actual land face 83A and the lower side actual land face 83B is referred to as a so-called shear droop shape, and its gradient is about 1/2000 to 1/500, which is extremely small. Each of the upper side actual land face 83A and the lower side actual land face 83B after the running-in operation has slight inclination and deformation and substantially becomes a sliding region (sliding face) that comes in contact with and slides on the inner wall face 12 of the cylinder liner 10.

### <Method for Manufacturing Ring Body of Oil Ring>

### (Production of Base Material)

Next, a method for manufacturing the ring body 72 of the oil ring 70 according to the present embodiment will be described. First, a linear wire rod having a desired cross-sectional shape is bent and formed to have a ring shape by a bending machine, which is not particularly illustrated, to produce the base material 90.

### (Buffing of Base Material)

Subsequently, the outer peripheral face of the ring-shaped base material 90 is polished or ground along the circumferential direction by means of buffing. By doing so, the base, which is the outer peripheral face of the base material 90, is smoothed. Note that the outer peripheral face of the base material 90 may be subjected to a nitriding treatment.

### (Physical Vapor Deposition Treatment)

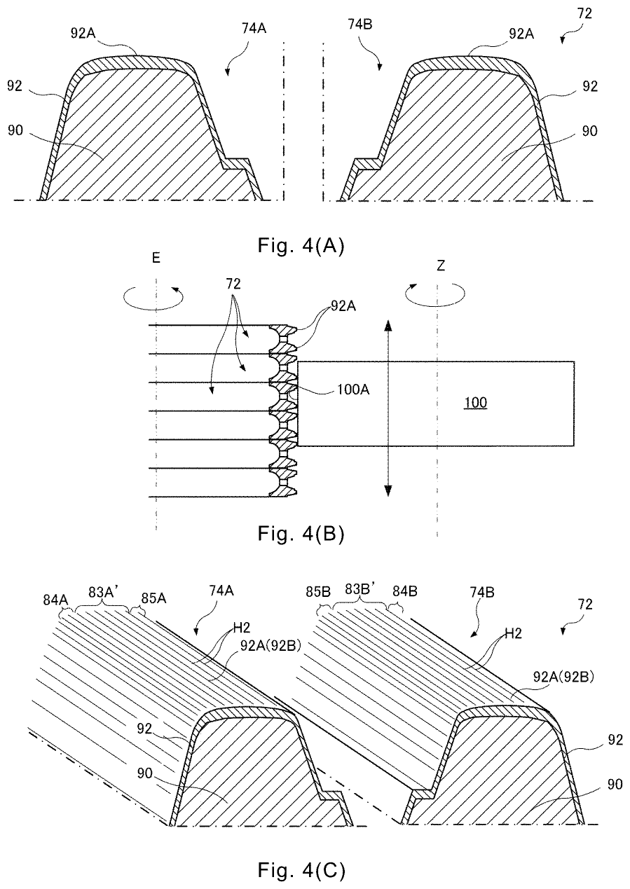

Thereafter, as illustrated in FIG. 4(A), the PVD film 92 is formed on the outer peripheral face of the base material 90 (the outer peripheral face will later be the upper side outer peripheral face 81A and the lower side outer peripheral face 81B) by means of a physical vapor deposition treatment. Herein, a chromium nitride film is formed. Note that, although it is not particularly illustrated in the figure, a film outer peripheral face 92A of the PVD film 92 immediately after the physical vapor deposition treatment is in a state where fine protrusions and recesses are randomly formed across its entirety. These fine protrusions and recesses are caused by a structure in which the deposition substances deposit by the physical vapor deposition treatment.

### (Buffing of PVD Film)

Subsequently, as illustrated in FIG. 4(B), the film outer peripheral face 92A of the PVD film 92 (the film outer peripheral face 92A will later be the upper side outer peripheral face 81A and the lower side outer peripheral face 81B) is subjected to buffing. In the present embodiment, a plurality of ring bodies 72 are collectively set on a rotator, which is not particularly illustrated, and are forcibly rotated around a center axis E. Also, a buff 100 made of cotton or felt and serving as a cylindrical polishing tool is installed next to the ring body 72 to have a posture in which a rotation axis Z of the buff itself is parallel to the center axis E of the ring body 72.

While an outer peripheral face 100A of the buff 100 abuts against the film outer peripheral face 92A of the ring body 72, the buff 100 is forcibly rotated around the center axis Z. At the same time, the buff 100 and the ring body 72 are moved relative to each other in the directions of the center axes E and Z. Note that, by allowing the rotating directions of the ring body 72 and the buff 100 to correspond to each other, the moving directions of the outer peripheral face 100A of the buff 100 and the film outer peripheral face 92A of the ring body 72 at the contact point between them become opposite, and the polishing efficiency is improved.

As a result, as illustrated in FIG. 4(C), the entirety or a part (the range that the buff 100 can come into contact with) of the film outer peripheral face 92A of the PVD film 92 is abraded by polishing or grinding. The face generated by the abrasion is herein defined as a peripheral-direction abrasion face 92B. The peripheral-direction hairlines H2 that extend in the circumferential direction are formed on the surface of the peripheral-direction abrasion face 92B. Due to the peripheral-direction abrasion face 92B, the upper side first inclined face 84A and the upper side second inclined face 85A, and the lower side first inclined face 84B and the lower side second inclined face 85B are formed.

Between the upper side first inclined face 84A and the upper side second inclined face 85A, an upper side lapping target region 83A′ is formed. Similarly, between the lower side first inclined face 84B and the lower side second inclined face 85B, a lower side lapping target region 83B′ is formed.

### (Lapping)

Subsequently, as illustrated in FIG. 5(A), the plurality of ring bodies 72 are collectively set on a fixing tool, which is not particularly illustrated, are inserted into an inner peripheral grinding face 120A of a cylindrical grinding tool (lapping machine) 120, and slide relative to each other in the axial direction. While the inside diameter of the inner peripheral grinding face 120A is set to have a similar length to that of each of the ring bodies 72, predetermined abrasive grains are provided between them, whereby the upper side outer peripheral face 81A and the lower side outer peripheral face 81B of the ring body 72 are ground or polished. Specifically, the upper side lapping target region 83A′ and the lower side lapping target region 83B′ in the peripheral-direction abrasion face 92B are abraded. In other words, the portions of the peripheral-direction abrasion face 92B outside of the upper side lapping target region 83A′ and the lower side lapping target region 83B′ remain the peripheral-direction abrasion face 92B as they are.

As a result, as illustrated in FIG. 5(B), the upper side actual land face 83A and the lower side actual land face 83B are formed by the region abraded by lapping. On the upper side actual land face 83A and the lower side actual land face 83B, the axial-direction hairlines H1 serving as polishing marks are formed.

### <Face Pressure Setting for Oil Ring>

Next, face pressure setting between the oil ring 70 and the cylinder liner 10 will be described. Here, face pressure of the oil ring 70 means a face pressure acting on the sliding face constituting the actual land widths f1 and f2 in the outer peripheral face 42 of the piston ring 40. Specifically, the face pressure is calculated by (2× tensile force)/(cylinder liner diameter×actual land width f).

In the present embodiment, the face pressure of the oil ring 70 is preferably set to 0.8 MPa or more, and more preferably set to 1.0 MPa or more. Furthermore, the face pressure is preferably set to 2.5 MPa or less, and more preferably set to 2.2 MPa or less.

### <Modification Example of Oil Ring>

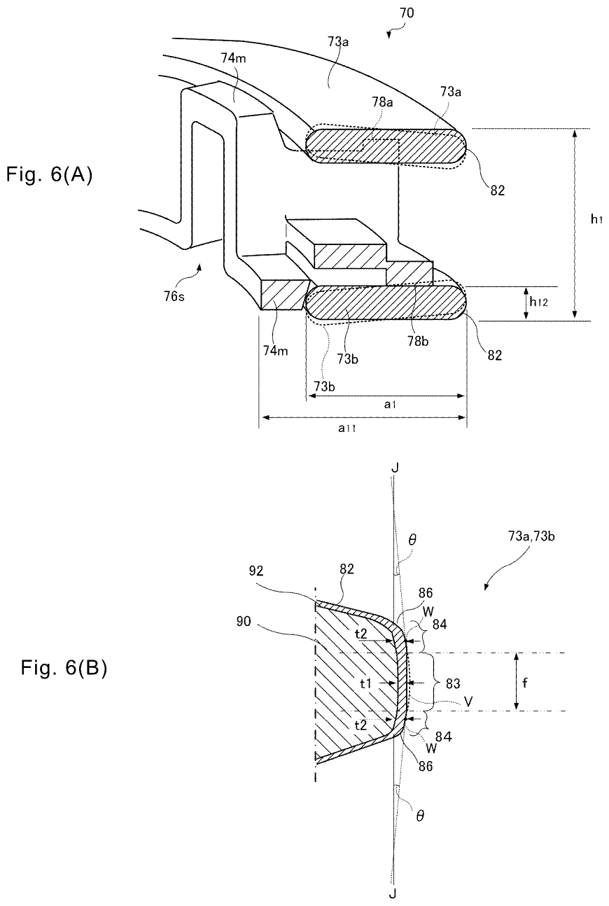

Although the two-piece-type oil ring has been used as the oil ring 70 of the above-mentioned embodiment, the present invention is not limited to this. For example, a three-piece-type oil ring such as an oil ring 70, whose enlarged view is illustrated in FIG. 6(A), can be employed. This oil ring 70 includes annular side rails 73a and 73b separated on the upper and lower sides and a spacer expander 76s arranged between the side rails 73a and 73b. The paired side rails 73a and 73b constitute the ring body as a set.

The spacer expander 76s is formed by plastically processing a steel material to have a waveform shape in which protrusions and recesses are provided in alternating repeats in the cylinder axial direction. With use of this waveform shape, an upper side support face 78a and a lower side support face 78b are formed and support the paired side rails 73a and 73b in the axial direction, respectively. At the inner-peripheral-side end portion of the spacer expander 76s, a tab 74m erected in an arch shape toward the outside in the axial direction is provided. The tabs 74m abut against the inner peripheral faces of the side rails 73a and 73b. The spacer expander 76s is incorporated into the ring groove of the piston 30 in a contracted state in the circumferential direction as the abutment joints thereof face each other. As a result, because of the restoring force of the spacer expander 76s, the tabs 74m press and bias the side rails 73a and 73b to the outside in the radial direction. When receiving the biasing force, the side rails 73a and 73b are inclined to the inside in the axial direction (combined nominal width direction) of the oil ring 70 as illustrated by the dotted lines. That is, paired outer peripheral faces 82 and 82 approach each other by an amount corresponding to the inclination.

The combined radial-direction thickness a₁₁ of the oil ring 70 is set to, for example, 4.0 mm or less, and preferably 3.0 mm or less. The combined axial-direction width (nominal width) h₁ is set to, for example, 4.0 mm or less, and preferably 2.0 mm or less. The thickness (radial-direction width) a₁ of each of the side rails 73a and 73b as a single unit is set to, for example, 4.0 mm or less, and preferably 3.0 mm or less. The width (axial-direction width) h₁₂ of the single unit is set to, for example, 1.0 mm or less, preferably 0.5 mm or less, and more preferably 0.4 mm or less.

As illustrated in the further enlarged view of FIG. 6(B), the outer peripheral faces 82 and 82 of the side rails 73a and 73b each have a so-called weak-barrel shape, which is a slightly protruded shape protruding toward the outside in the radial direction. Note that, here, for convenience of description, the dimension in the radial direction with respect to the dimension in the axial direction is significantly exaggerated to emphasize the protruded shape of each of the outer peripheral faces.

The outer peripheral face 82 is a surface of the hard film (hereinbelow, the PVD film) 92 formed by means of a physical vapor deposition treatment applied to the base material 90. A part of the outer peripheral face 82 in the axial direction is provided with an actual land face 83 that actually abuts against the inner wall face 12 of the cylinder liner 10. The actual land face 83B is a flat face (refer to dotted line V) created by abrasion of a part of the surface side of the PVD film 92, this abrasion being achieved by means of lapping in which polishing or grinding is performed in the axial direction (strip width direction). The actual land face 83 is a strip-like region that extends in the circumferential direction of the outer peripheral face 82. The fine axial-direction hairlines H1 that extend in the axial direction (strip width direction) and that serves as polishing marks are formed on the surface of the actual land face 83.

Furthermore, in the outer peripheral face 82, the edges of the actual land face 83 in the axial direction (strip width direction) are provided with inclined faces 84, respectively. Each of the inclined faces 84 is an inclined region separated from the inner wall face 12 of the cylinder liner 10. Each of the inclined faces 84 is a strip-like region that extends in the circumferential direction.

In addition, on the further outside of each of the inclined faces 84 in the axial direction, a corner 86 is formed. In the cross-sectional view in the axial direction, the corner 86 is a region in which the gradient of the inclination changes rapidly from the inclined face 84 toward the lateral side of the side rail 73a or 73b.

The inclined face 84 is a surface obtained by polishing or grinding a part of the PVD film 92 on the surface side along the circumferential direction by means of buffing. As a result, the inclined face 84 is smoothed along the circumferential direction. Fine peripheral-direction hairlines that extend in the circumferential direction (strip length direction) and that serves as polishing marks, are formed on the surface of the inclined face 84.

The dimension of the actual land width f of the actual land face 83 before a running-in operation is preferably set to 0.05 mm or more. The dimension is more preferably set to 0.10 mm or more, and still more preferably set to more than 0.13 mm. Also, the dimension of the actual land width f is preferably set to 0.40 mm or less. The dimension is more preferably set to 0.35 mm or less, and still more preferably set to less than 0.30 mm.

The total actual land width F obtained by summing up the actual land widths f of the paired outer peripheral faces 82 and 82 is preferably set to 0.10 mm or more. The width is more preferably set to 0.20 mm or more, and still more preferably set to more than 0.26 mm. The total actual land width F is preferably set to 0.80 mm or less. The width is more preferably set to 0.70 mm or less, and still more preferably set to less than 0.60 mm. Furthermore, a face pressure acting on the actual land face 83 is preferably set to 0.8 MPa or more, and more preferably set to 1.0 MPa or more. The face pressure is preferably set to 2.5 MPa or less, and more preferably set to 2.2 MPa or less.

### <Friction State Between Cylinder Liner and Oil Ring>

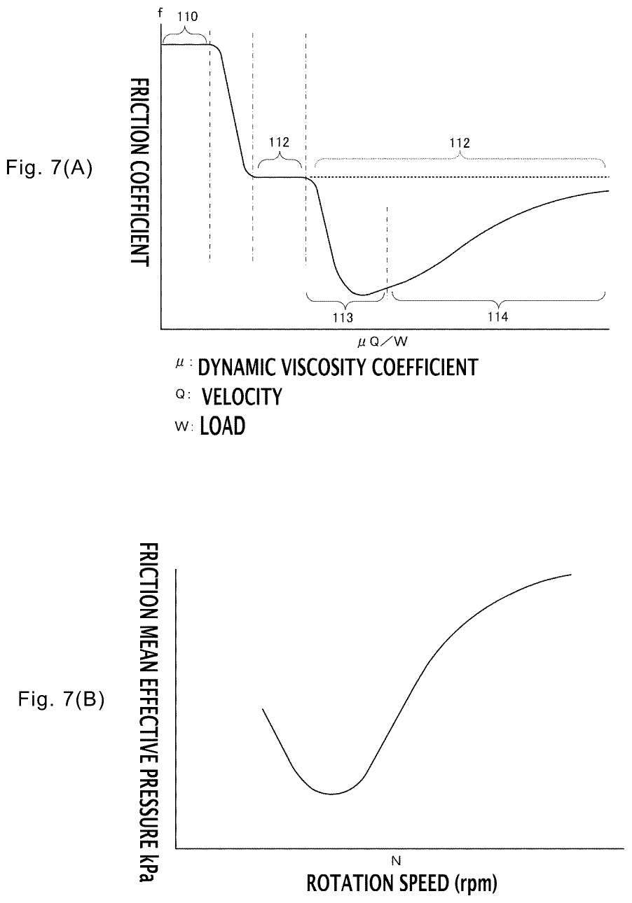

Next, a friction state between the cylinder liner and the oil ring will be described. Changes of a friction coefficient at the time of common sliding are expressed as the Stribeck curve illustrated in FIG. 7(A). In this Stribeck curve, the friction states are classified into a friction state in a solid contact regime 110, in which sliding is performed in a direct contact state, a friction state in a boundary lubrication regime 112, in which sliding is performed with an oil film interposed therebetween, and a friction state in a hydrodynamic lubrication regime 114, in which sliding is performed with a viscous lubrication oil film interposed therebetween. Also, a friction state in a mixed lubrication regime 113, in which the states of the boundary lubrication regime 112 and the hydrodynamic lubrication regime 114 are mixed, exists between the boundary lubrication regime 112 and the hydrodynamic lubrication regime 114. In the Stribeck curve, the horizontal axis represents “dynamic viscosity (dynamic viscosity coefficient) μ”×“velocity Q”/“contact load W” in a log scale while the vertical axis represents a friction coefficient (f). Therefore, the frictional force can be the lowest in the hydrodynamic lubrication regime 114 or the mixed lubrication regime 113, and efficient use of these regimes 114 and 113 leads to low friction, that is, low fuel consumption. On the other hand, in a case where the curve cannot shift from the middle of the boundary lubrication regime 112 to the hydrodynamic lubrication regime 114 even when the velocity Q increases, the boundary lubrication regime 112 continues as it is to the high-velocity region as illustrated by the dotted line.

Meanwhile, the frictional force of the hydrodynamic lubrication regime 114 is mostly shear resistance of oil, and the shear resistance is defined as (viscosity)×(velocity)×(area)/(oil film thickness). That is, reduction in the shear area directly leads to reduction in the frictional force.

Therefore, in the present embodiment, low friction is achieved with a quick shift in the curve to the hydrodynamic lubrication regime 114, this shift being achieved by oil being actively supplied to the upper side actual land face 83A and the lower side actual land face 83B of the oil ring 70 from the upper side first inclined face 84A, the upper side second inclined face 85A, and the lower side first inclined face 84B and the lower side second inclined face 85B, which are formed on both sides thereof. In addition to this, a so-called dimple liner technique is applied to the cylinder liner 10, which will be described in detail below. In the dimple liner technique, by forming recesses at a stroke center region of the cylinder liner 10 and reducing the substantial area in which the shear resistance of oil is generated, reduction of a frictional force is achieved more efficiently.

The Stribeck curve in FIG. 7(A) illustrates dynamic changes of the friction coefficient (f) in one stroke of the piston 30. Another index of assessing the friction state is friction mean effective pressure (FMEP). The friction mean effective pressure indicates a value obtained by dividing frictional work per cycle by stroke volume. A curve of the friction mean effective pressure (FMEP curve) is illustrated in FIG. 7(B). In the FMEP curve, the horizontal axis represents a rotation speed (N) while the vertical axis represents a friction mean effective pressure (kPa). As the rotation speed (N) becomes higher, the proportion of the hydrodynamic lubrication regime 114 in one stroke becomes higher. Conversely, as the rotation speed (N) becomes lower, the proportion of the hydrodynamic lubrication regime 114 in one stroke becomes lower, and the proportion of the mixed lubrication regime 113 (or the boundary lubrication regime 112) becomes higher. Accordingly, the shape of the FMEP curve in FIG. 7(B) is relatively similar to the shape of the hydrodynamic lubrication regime 114 and the mixed lubrication regime 113 in the Stribeck curve in FIG. 7(A).

### <Dimple Technique for Cylinder Liner>

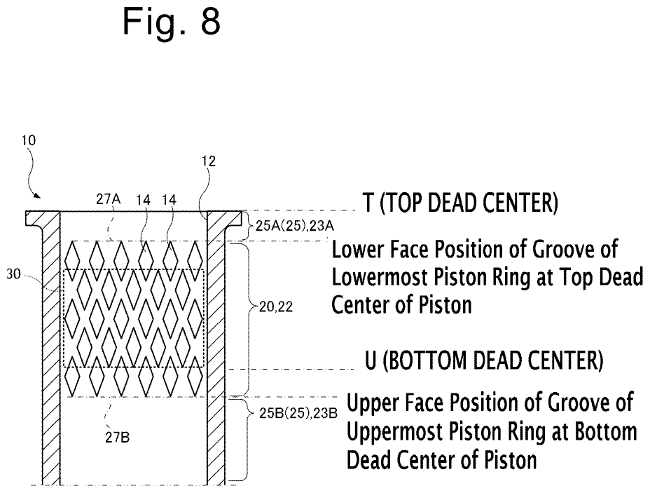

Next, the cylinder liner 10 suitably used with the oil ring 70 according to the present embodiment will be described. As illustrated in FIG. 8, a plurality of recesses 14 are formed on the inner wall face 12 of the cylinder liner 10. The recesses 14 are formed in a stroke center region 20 on the inner wall face 12. The stroke center region 20 refers to the entire region or a partial region of the maximum range from the lower face position of the ring groove of the lowermost piston ring at top dead center T of the piston 30 to the upper face position of the ring groove of the uppermost piston ring at bottom dead center U of the piston 30 (illustrated here is a case where the entire range is the stroke center region 20, in the entirety of which the recesses 14 are formed). In a case where the region outside of the stroke center region 20 is defined as an outside region 25, the outside region 25 includes an upper side outside region 25A provided on the top dead center side of the stroke center region 20 and a lower side outside region 25B provided on the bottom dead center side of the stroke center region 20. When the piston 30 reciprocates in the cylinder liner 10, the piston 30 repeatedly passes the upper side outside region 25A, the stroke center region 20, the lower side outside region 25B, the stroke center region 20, and the upper side outside region 25A in this order. Note that the boundary between the upper side outside region 25A and the stroke center region 20 is defined as an upper side boundary 27A, and the boundary between the lower side outside region 25B and the stroke center region 20 is defined as a lower side boundary 27B.

It is possible to form the plurality of recesses 14 outside of the stroke center region 20. However, from the viewpoint of the oil consumption amount (LOC), it is preferable to form the recesses 14 only inside the stroke center region 20.

### <Dimples Formed in Cylinder Liner>

The recesses 14 are arranged on the inner wall face 12 of the stroke center region 20 so that at least one recess 14 may exist on the cross-section in any direction perpendicular to the axis. That is, the recesses 14 are arranged to overlap with each other in the axial direction. Therefore, the outer peripheral face of the piston ring that passes the stroke center region 20 is opposed to at least one recess 14 at all times. On the other hand, no recess 14 is formed in the upper side outside region 25A and the lower side outside region 25B.

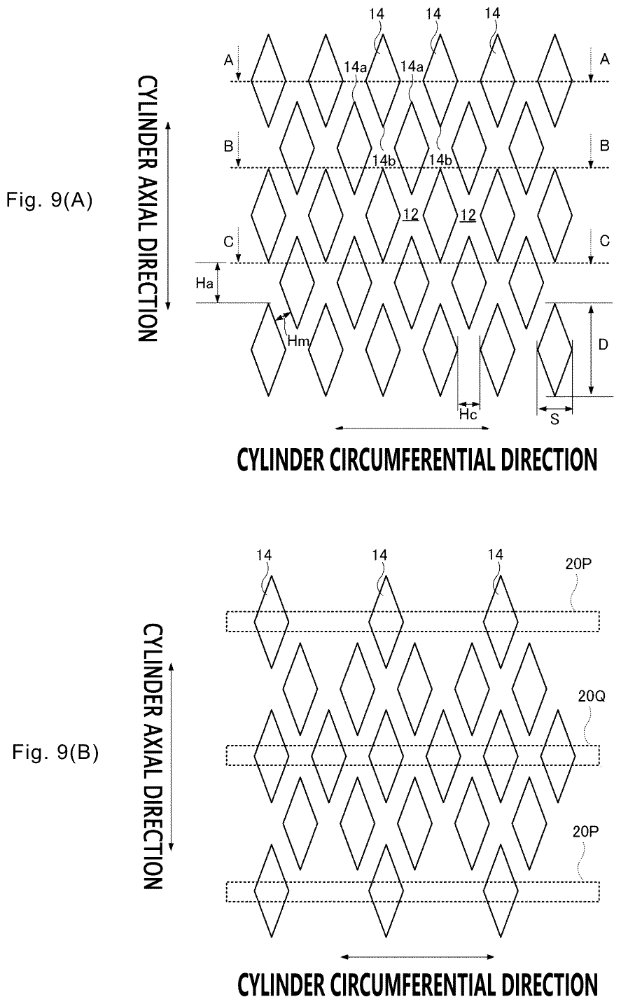

The recess 14 has a quadrangular shape (a square or a rectangle) arranged obliquely to the axial direction, and as a result, the plurality of recesses 14 are arranged in an oblique lattice shape as a whole. In this layout, as illustrated by the developed view in FIG. 9(A), in a case where a certain recess 14 is focused, a lowermost point 14b of the recess 14 in the axial direction is located on the lower side, in the axial direction, of an uppermost point 14a of another recess 14 in the axial direction. In this manner, since the plurality of recesses 14 overlap in the axial direction, the recesses 14 can exist at all times on the cross-section in the direction perpendicular to the axis at any position (for example, the cross-sections indicated by arrows A, arrows B, and arrows C) in the stroke center region 20. Here, in the stroke center region 20, the plurality of recesses 14 having the same areas are arranged uniformly in the planar directions (the axial direction and the circumferential direction).

Note that, as illustrated by the developed view in FIG. 9(B), the plurality of recesses 14 having the same areas may be arranged non-uniformly in the planar directions. Here, in a strip-like region 20P in the circumferential direction at the end portion of the stroke center region 20 in the axial direction, the area of the plurality of recesses 14 is small. In a strip-like region 20Q in the circumferential direction at the center portion of the stroke center region 20 in the axial direction, the area of the plurality of recesses 14 is large.

The dimension and shape of the recess 14 are not limited to particular ones, and are appropriately selected according to the dimensions and purposes of the cylinder and the piston ring. For example, the recess 14 can be formed to have a slit-like or strip-like shape so as to penetrate (or extend) in the cylinder axial direction in the stroke center region 20. However, in consideration of the viewpoint of the airtightness of the cylinder, a maximum average length D (refer to FIG. 9(A)) of the recess 14 in the cylinder axial direction is preferably equal to or less than the length (width), in the cylinder axial direction, of the piston ring (top ring) located at the uppermost position of the piston, that is, specifically about 5 to 100% thereof. In a case where the maximum lengths of the plurality of recesses 14 in the axial direction vary, the average length D of the recess 14 means the average value of the maximum lengths.

A maximum average length S of the recess 14 in the cylinder circumferential direction is preferably in the range from 0.1 mm to 15 mm, and desirably in the range from 0.3 mm to 5 mm. In a case where the length is smaller than these ranges, the sliding area reduction effect due to the recesses 14 themselves may not be achieved sufficiently. On the other hand, in a case where the length is larger than these ranges, a part of the piston ring may easily go into the recess, and a problem such as deformation of the piston ring may occur.

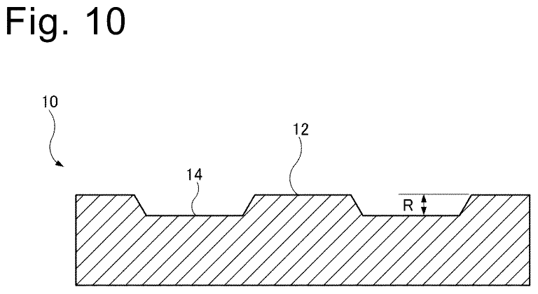

As illustrated in FIG. 10, a maximum average length R (maximum average depth R) of the recess 14 in the cylinder radial direction is preferably in the range from 0.1 μm to 1000 μm, and desirably in the range from 0.1 μm to 500 μm. The length R is more desirably set in the range from 0.1 μm to 50 μm. In a case where the maximum average length R of the recess 14 in the cylinder radial direction is smaller than these ranges, the sliding area reduction effect due to the recesses 14 themselves may not be achieved sufficiently. On the other hand, in a case where the length is attempted to be larger than these ranges, processing may be difficult, and a problem such as requirement of enlarging the thickness of the cylinder may occur. Note that, in the recess 14 in FIG. 10, the length in the cylinder radial direction with respect to the length in the cylinder circumferential direction is significantly exaggerated for convenience of description.

Returning to FIG. 9, the average value of minimum distances Hc, in the cylinder circumferential direction, between the recesses 14 located in the same position in the axial direction and adjacent in the circumferential direction is preferably in the range from 0.05 mm to 15 mm, and especially preferably in the range from 0.1 mm to 5.0 mm. In a case where the value is lower than these ranges, the contact area (sliding area) between the piston ring and the cylinder liner is too small to achieve stable sliding. Conversely, in a case where the value is higher than these ranges, the sliding area reduction effect due to the recesses 14 themselves may not be achieved sufficiently.

The average value of minimum distances Ha, in the cylinder axial direction, between the recesses 14 located in the same position in the circumferential direction and adjacent in the axial direction is preferably in the range from 0.05 mm to 15 mm, and especially preferably in the range from 0.1 mm to 5.0 mm. In a case where the value is lower than these ranges, the contact area (sliding area) between the piston ring and the cylinder liner is too small to achieve stable sliding. Conversely, in a case where the value is higher than these ranges, the sliding area reduction effect due to the recesses 14 themselves may not be achieved sufficiently.

Furthermore, the average value of minimum distances Hm between the adjacent recesses 14 in any direction is preferably in the range from 0.001 mm to 15 mm, and especially preferably in the range from 0.001 mm to 5.0 mm. In a case where the value is higher than these ranges, the sliding area reduction effect due to the recesses 14 themselves may not be achieved sufficiently.

In other words, these distances Hc, Ha, and Hm each have the same meaning of a minimum width, in each direction, of the inner wall face 12 left between the adjacent recesses 14.

In the present embodiment, the average value of the minimum distances Ha in the cylinder axial direction is preferably in the range from 0.05 mm to 15 mm, and further preferably in the range from 0.1 mm to 5.0 mm. By ensuring the distance Ha of the inner wall face 12 in the cylinder axial direction to an appropriate value with regard to the recesses 14 and the inner wall face 12 therearound to expand the range of the hydrodynamic lubrication regime 114 of the piston ring 40 that slides in the cylinder axial direction illustrated in FIG. 7(A), a local face pressure fluctuation acting on the piston ring 40 can be reduced.

### Example 1

The ring bodies 72 of the two-piece-type oil rings 70 according to the present embodiment were manufactured having two kinds of manufacturing conditions for buffing on the PVD films 92, and the peripheral-direction surface texture parameters of the upper side first inclined faces 84A, the upper side second inclined faces 85A, the lower side first inclined faces 84B, and the lower side second inclined faces 85B were measured. The oil ring 70 manufactured under a first manufacturing condition is a first example, and the oil ring 70 manufactured under a second manufacturing condition is a second example. Also, an oil ring in which no buffing is performed on the PVD film 92 is a comparative example.

In the first manufacturing condition, which is used in the first example, alumina (Al₂O₃) was used as abrasive grains, and the buff 100 which had a flap-type structure in which the polishing cloths were fixed in a radial manner with respect to the rotation axis and which was soft in hardness was used. In the buffing, the buff 100 reciprocated once in the axial direction with its feeding speed in the axial direction constant. The rotation speed of each of the buff 100 and the ring body 72 was set to 300 rpm, and the rotating direction in the first-half trip and the rotating direction in the last-half trip were made opposite. The abutting force of the buff 100 against the ring body 72 was set to a level in which the amount of current supplied to the motor became larger than in a non-contact state, and in which predetermined load was applied.

In the second manufacturing condition, which is used in the second example, silicon carbide (SiC) was used as abrasive grains, and the buff 100 which had a normal-type structure in which the polishing cloth was wound in a spiral manner with respect to the rotation axis and which was hard in hardness was used. In the buffing, the buff 100 reciprocated once in the axial direction with its feeding speed in the axial direction same as in the first manufacturing condition. The rotation speed of each of the buff 100 and the ring body 72 was set to 300 rpm, and the rotating direction in the first-half trip and the rotating direction in the last-half trip were made opposite. The abutting force of the buff 100 against the ring body 72 was set to a level in which the amount of current supplied to the motor became larger than in a non-contact state, and in which predetermined load was applied.

In all of the first example, the second example, and the comparative example, as the conditions for lapping, a honing sleeve having a spiral groove on the inner peripheral face was used, abrasive grains were provided, and reciprocating movement was performed in the up-down axial direction predetermined times for polishing or grinding.

### (Measurement of Peripheral-Direction Surface Texture Parameters)

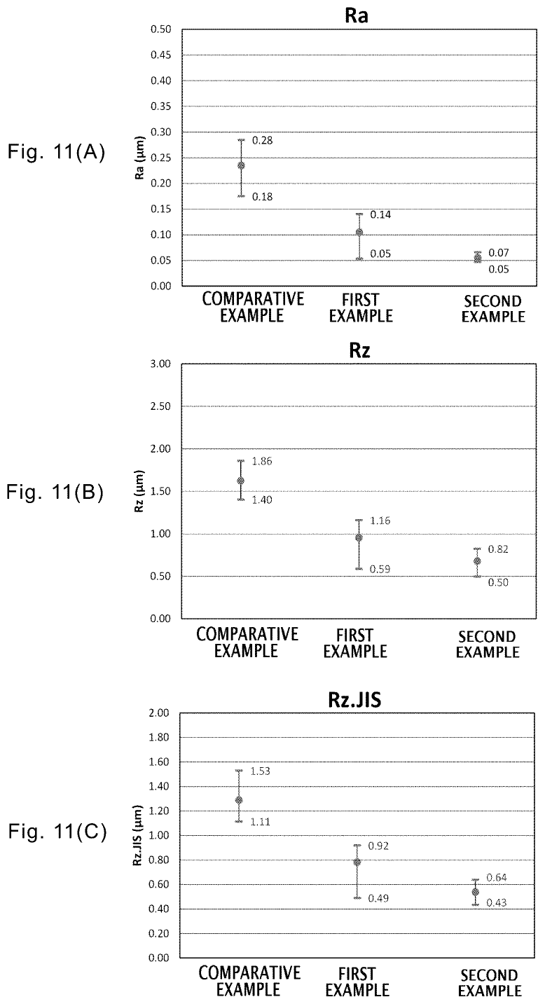

In the first example, the second example, and the comparative example, the peripheral-direction surface texture parameters were measured. Measurement was performed three times per inclined face. The upper limit value, the lower limit value, and the average value of the upper and lower limit values of each of the twelve measurement results of the upper side first inclined faces 84A, the upper side second inclined faces 85A, the lower side first inclined faces 84B, and the lower side second inclined faces 85B are illustrated in FIGS. 11 to 13.

As illustrated in FIG. 11(A), as for the arithmetic mean roughness Ra, the measurement value was 0.14 μm or less in the first and second examples. Specifically, the average value in the first example was 0.10 μm, and the average value in the second example was 0.06 μm. On the other hand, the average value in the comparative example was 0.23 μm.

As illustrated in FIG. 11(B), as for the maximum height Rz, the measurement value was 1.16 μm or less in the first and second examples. Specifically, the average value in the first example was 0.95 μm, and the average value in the second example was 0.68 μm. On the other hand, the average value in the comparative example was 1.62 μm.

As illustrated in FIG. 11(C), as for the ten point height of roughness profile RzJIS, the measurement value was 0.92 μm or less in the first and second examples. Specifically, the average value in the first example was 0.78 μm, and the average value in the second example was 0.54 μm. On the other hand, the average value in the comparative example was 1.29 μm.

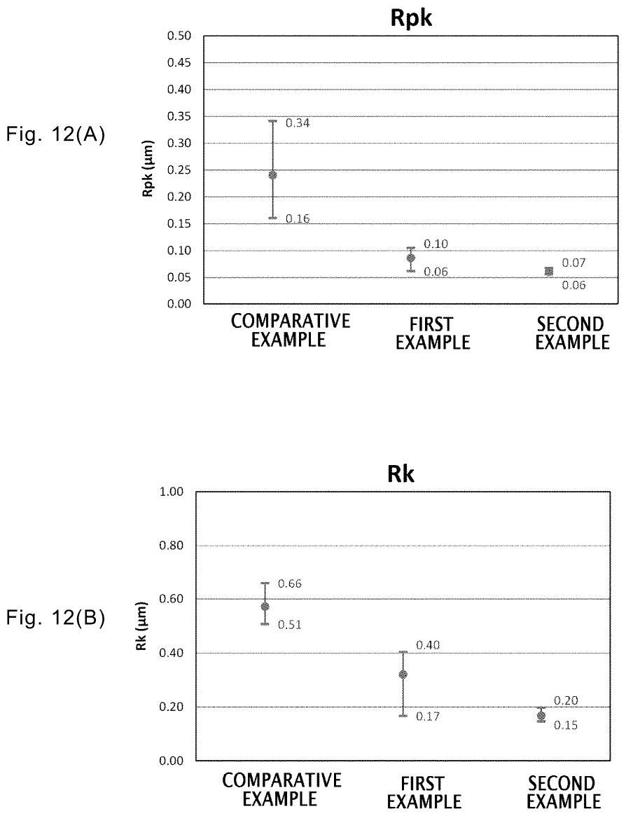

As illustrated in FIG. 12(A), as for the reduced peak height Rpk, the measurement value was 0.10 μm or less in the first and second examples. Specifically, the average value in the first example was 0.09 μm, and the average value in the second example was 0.06 μm. On the other hand, the average value in the comparative example was 0.24 μm.

As illustrated in FIG. 12(B), as for the core roughness depth Rk, the measurement value was 0.40 μm or less in the first and second examples. Specifically, the average value in the first example was 0.32 μm, and the average value in the second example was 0.17 μm. On the other hand, the average value in the comparative example was 0.57 μm.

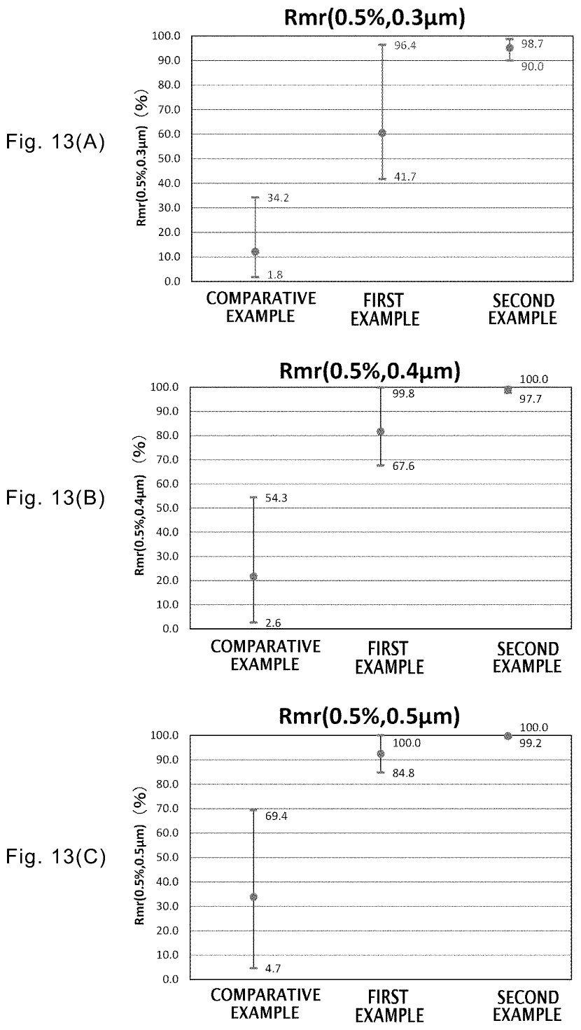

As illustrated in FIG. 13(A), as for the material ratio Rmr in a case of generating a 0.3 μm height decrease with a 0.5% position as a starting point, the measurement value was 41.7% or more in the first and second examples. Specifically, the average value in the first example was 60.4%, and the average value in the second example was 95.2%. On the other hand, the average value in the comparative example was 12.2%.

As illustrated in FIG. 13(B), as for the material ratio Rmr in a case of generating a 0.4 μm height decrease with a 0.5% position as a starting point, the measurement value was 67.6% or more in the first and second examples. Specifically, the average value in the first example was 81.6%, and the average value in the second example was 99.0%. On the other hand, the average value in the comparative example was 21.6%.

As illustrated in FIG. 13(C), as for the material ratio Rmr in a case of generating a 0.5 μm height decrease with a 0.5% position as a starting point, the measurement value was 84.8% or more in the first and second examples. Specifically, the average value in the first example was 92.5%, and the average value in the second example was 99.7%. On the other hand, the average value in the comparative example was 33.8%.

### (Three-Dimensional Image Capturing of Surface Texture)

Next, in the first example, the second example, and the comparative example, a three-dimensional image of the surface texture of the ring body 72 was captured. As an image capturing device, a confocal microscope “OPTELICS HYBRID C3” (100-power objective lens) manufactured by Lasertec Corporation was used.

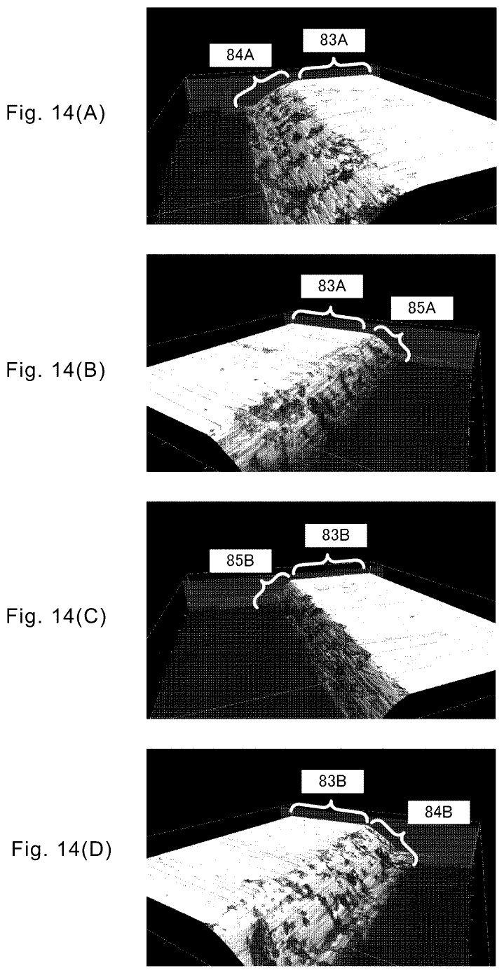

FIGS. 14(A) to 14(D) illustrate three-dimensional image capturing results in the first example, in which FIG. 14(A) illustrates the upper side first inclined face 84A and the upper side actual land face 83A of the ring body 72, FIG. 14(B) illustrates the upper side second inclined face 85A and the upper side actual land face 83A of the ring body 72, FIG. 14(C) illustrates the lower side second inclined face 85B and the lower side actual land face 83B of the ring body 72, and FIG. 14(D) illustrates the lower side first inclined face 84B and the lower side actual land face 83B.

The upper side first inclined face 84A, the upper side second inclined face 85A, the lower side second inclined face 85B, and the lower side first inclined face 84B are all provided with peripheral-direction hairlines and are smooth along the circumferential direction. As a result, the boundary between the upper side actual land face 83A and the upper side first inclined face 84A, the boundary between the upper side actual land face 83A and the upper side second inclined face 85A, the boundary between the lower side actual land face 83B and the lower side second inclined face 85B, and the boundary between the lower side actual land face 83B and the lower side first inclined face 84B are straight. This brings about a state in which oil easily enters the actual land faces from the respective inclined faces and a structure in which the oil film is easily maintained.

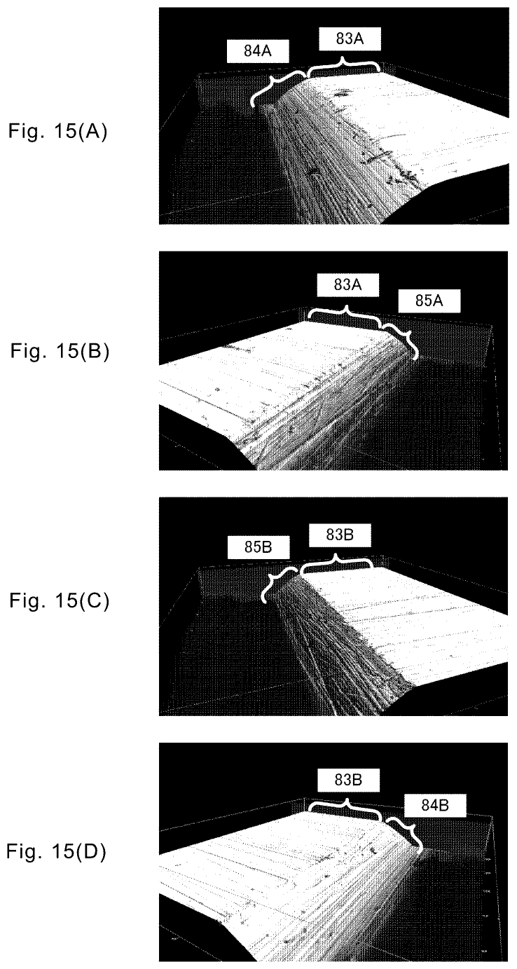

FIGS. 15(A) to 15(D) illustrate three-dimensional image capturing results in the second example, in which FIG. 15(A) illustrates the upper side first inclined face 84A and the upper side actual land face 83A of the ring body 72, FIG. 15(B) illustrates the upper side second inclined face 85A and the upper side actual land face 83A of the ring body 72, FIG. 15(C) illustrates the lower side second inclined face 85B and the lower side actual land face 83B of the ring body 72, and FIG. 15(D) illustrates the lower side first inclined face 84B and the lower side actual land face 83B.

The upper side first inclined face 84A, the upper side second inclined face 85A, the lower side second inclined face 85B, and the lower side first inclined face 84B are all provided with peripheral-direction hairlines and are smooth along the circumferential direction. As a result, the boundary between the upper side actual land face 83A and the upper side first inclined face 84A, the boundary between the upper side actual land face 83A and the upper side second inclined face 85A, the boundary between the lower side actual land face 83B and the lower side second inclined face 85B, and the boundary between the lower side actual land face 83B and the lower side first inclined face 84B are straight. This brings about a state in which oil easily enters the actual land faces from the respective inclined faces and a structure in which the oil film is easily maintained.

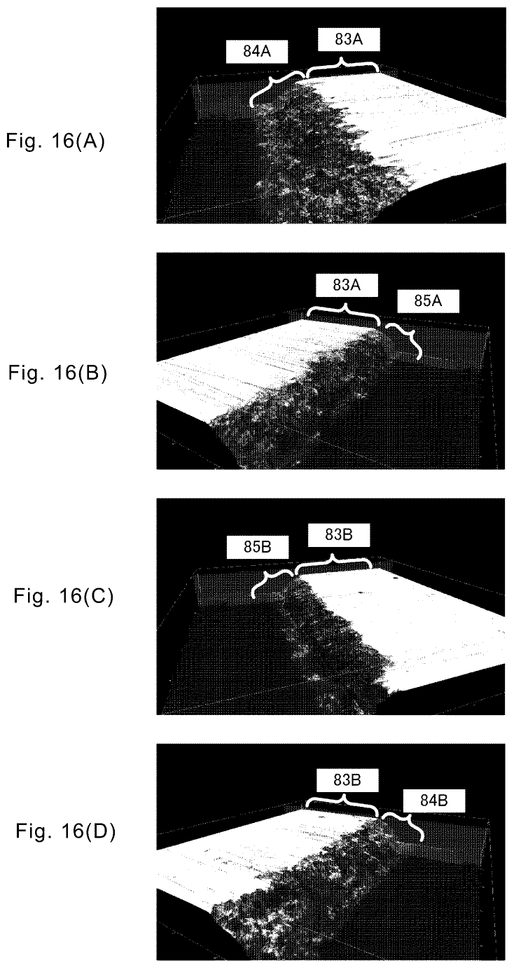

FIGS. 16(A) to 16(D) illustrate three-dimensional image capturing results in the comparative example, in which FIG. 16(A) illustrates the upper side first inclined face 84A and the upper side actual land face 83A of the ring body 72, FIG. 16(B) illustrates the upper side second inclined face 85A and the upper side actual land face 83A of the ring body 72, FIG. 16(C) illustrates the lower side second inclined face 85B and the lower side actual land face 83B of the ring body 72, and FIG. 16(D) illustrates the lower side first inclined face 84B and the lower side actual land face 83B.

Since the physical vapor deposition treatment is a method for forming a film by evaporating a metal, a compound, or the like and depositing it on the oil ring, fine protrusions and recesses are randomly formed on the surfaces of all of the upper side first inclined face 84A, the upper side second inclined face 85A, the lower side second inclined face 85B, and the lower side first inclined face 84B. Therefore, the faces are inferior in smoothness to those in the first and second examples. As a result, the boundary between the upper side actual land face 83A and the upper side first inclined face 84A, the boundary between the upper side actual land face 83A and the upper side second inclined face 85A, the boundary between the lower side actual land face 83B and the lower side second inclined face 85B, and the boundary between the lower side actual land face 83B and the lower side first inclined face 84B are in a random saw blade state. This brings about a structure in which the oil film is easily destroyed when oil enters the actual land faces from the respective inclined faces.

### (FMEP Curve)

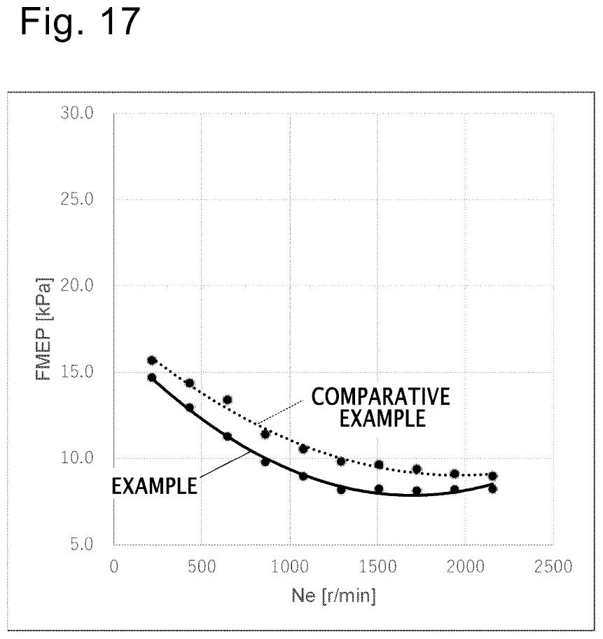

Next, FIG. 17 illustrates a result of measuring the FMEP using the oil ring 70 in which the oil body 72 of the second example was employed and a result of measuring the FMEP using the oil ring 70 in which the oil body of the comparative example was employed. At the time of measurement, a tensile force of 22.6 N was given to the oil ring 70 by the coil expander 76C (the face pressure of the actual land face was set to 1.75 Mpa). As the cylinder liner 10, one that employed the dimple liner technique illustrated in FIG. 10 was used.

As is apparent from FIG. 17, in a case of using the oil ring 70 of the second example, the FMEP is lower by about 1 kPa to 2 kPa on average than in the comparative example. In particular, since the value becomes lower even in the low rotation speed range, it is estimated that the mixed lubrication regime 113 (or the boundary lubrication regime 112) ranges over the low rotation speed side, and that the second example achieves a lubrication state, in which the oil film is harder to be destroyed than the comparative example.

As described above, with the oil ring 70 according to the present embodiment, the upper side first inclined face 84A, the upper side second inclined face 85A, the lower side first inclined face 84B, and the lower side second inclined face 85B included in the PVD film 92 are subjected to buffing along the circumferential direction, and the surfaces thereof are smoothed. As a result, the frictional resistance is reduced at the time of sliding on the cylinder liner 10. In addition, due to these inclined faces, the oil film is hard to be destroyed, and the shear resistance of the oil film is thus reduced.

Furthermore, in the present embodiment, after the PVD film 92 is subjected to buffing along the circumferential direction, a part of the PVD film 92 is subjected to lapping along the axial direction, thereby forming the upper side actual land face 83A and the lower side actual land face 83B. As a result, the boundary between the upper side first inclined face 84A and the upper side actual land face 83A, the boundary between the upper side second inclined face 85A and the upper side actual land face 83A, the boundary between the lower side first inclined face 84B and the lower side actual land face 83B, and the boundary between the lower side second inclined face 85B and the lower side actual land face 83B extend in a straight form in the circumferential direction. Due to the improvement of the straightness accuracy in the boundaries, the frictional resistance is reduced at the time of sliding on the cylinder liner 10.

Note that, in the present embodiment, although the chromium nitride film has been used as an example of the film formed in the physical vapor deposition treatment, the present invention is not limited to this, and another physical vapor deposition film such as a hard carbon film can be used. Also, although the oil ring is preferably applied to a diesel engine, the oil ring can be applied to a gasoline engine that uses a cylinder bore. Furthermore, the present invention is not limited to this, and can be applied to other internal combustion engines.

Note that the present invention is not limited to the above-described embodiments, and it goes without saying that various modifications can be made without departing from the gist of the present invention.

1. An oil ring that is a multi-piece-type oil ring provided on a piston of an internal combustion engine comprising a ring body including a rail, and an expander applying a tensile force to the ring body, wherein:
the rail of the ring body is provided with a film formed by means of a physical vapor deposition treatment;
an outer peripheral face of the rail formed by the film includes:
an actual land face that is formed to have a strip shape that extends in a circumferential direction and that abuts against and slides on an inner wall face of a cylinder of the internal combustion engine; and
an inclined face that continues from an edge of the actual land face in an axial direction to an outside in the axial direction and has a larger distance from the inner wall face on a further outside in the axial direction; and
the inclined face includes a face obtained by polishing or grinding a surface of the film along the circumferential direction.

2. The oil ring according to claim 1, wherein the actual land face is constituted by a face obtained by polishing or grinding a surface of the film along the axial direction.

3. The oil ring according to claim 2, wherein, in a case where a position in which an inclination angle of the inclined face with reference to the axial direction is 7° is defined as an assessment position, a reduced peak height Rpk obtained by measuring the assessment position along the circumferential direction is 0.15 μm or less.

4. The oil ring according to claim 2, wherein, in a case where a position in which an inclination angle of the inclined face with reference to the axial direction is 7° is defined as an assessment position, a material ratio Rmr, in a case of generating a 0.3 μm height decrease with a 0.5% position as a starting point, obtained by measuring the assessment position along the circumferential direction is 35% or more.

5. The oil ring according to claim 1, wherein the inclined face includes a hairline that extends in the circumferential direction and that is formed by the polishing or the grinding.

6. The oil ring according to claim 5, wherein the actual land face includes a hairline that extends in the axial direction and that is formed by polishing or grinding.

7. The oil ring according to claim 1, wherein the film is a chromium nitride-based alloy film or a hard carbon film.

8. A method for manufacturing an oil ring that is a multi-piece-type oil ring provided on a piston of an internal combustion engine including a ring body having a rail, and an expander applying a tensile force to the ring body, the method comprising the steps of:
forming a film on the rail of the ring body by means of a physical vapor deposition treatment;
forming a peripheral-direction abrasion face on a surface of the film by polishing or grinding an outer peripheral face of the rail formed by the film along a circumferential direction; and
forming, on a surface of the film, an actual land face that abuts against and slides on an inner wall face of a cylinder of the internal combustion engine by polishing or grinding a part of the peripheral-direction abrasion face along an axial direction, wherein
by leaving the peripheral-direction abrasion face in a portion from an edge of the actual land face in the axial direction to an outside in the axial direction, the peripheral-direction abrasion face is allowed to serve as an inclined face which has a larger distance from the inner wall face on a further outside in the axial direction.
